(19) United States
(12) Patent Application Publication
(10) Pub. No.: US 2008/0232280 A1
(43) Pub. Date: Sep. 25, 2008

(54) Registration method of multiple care-of address

(75) Inventors: Seung-Hee Kim, Daejeon (KR); Gyung-Chul Shin, Daejeon (KR); Dae-Sik Kim, Daejeon (KR); Jin-Sung Cho, Suwon-si (KR); Choong-Yong Shin, Yongin-si (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon (KR); Industry Academic Cooperation Foundation of KyungHee University, Yongin-si (KR)

(21) Appl. No.: 11/980,368

(22) Filed: Oct. 31, 2007

(30) Foreign Application Priority Data
Mar. 19, 2007 (KR) 10-2007-0026645

(51) Int. Cl. H04B 7/00

(52) U.S. Cl. 370/310

(57) ABSTRACT

The present invention relates to a binding update identifier sub-option field configuration method and a binding update information configuration method. In the method, a binding update identifier sub-option field including current used interface and data characteristics and corresponding to one interface of the plurality of interfaces is generated, the binding update identifier sub-option field is transmitted to a home agent and a correspondent node, a care-of address corresponding to a binding update identifier is stored, and binding update is performed.

### CROSS-REFERENCE TO RELATED APPLICATION

This application claims priority to and the benefit of Korean Patent Application No. 10-2007-0026645 filed in the Korean Intellectual Property Office on Mar. 19, 2007, the entire content of which is incorporated herein by reference.

### BACKGROUND OF THE INVENTION

(a) Field of the Invention

The present invention relates to a multiple care-of address registration method. More particularly, the present invention relates to a multiple care-of address registration method of a mobile terminal having a plurality of care-of addresses respectively corresponding to a plurality of interfaces performing data transmission by using a binding update identifier (BID) sub-option field.

This work was supported by the IT R&D program of MIC/IITA[2006-S-003-01, Research on service platform for the next generation mobile communications].

(b) Description of the Related Art

A binding update identifier (BID) sub-option is information generated by a mobile terminal based on a mobile IPv6 (MIPv6) mechanism, and that is, the mobile terminal respectively allocates a care-of address (CoA) to a plurality of interfaces that are capable of data transmission.

The BID sub-option has been suggested by the IETF MONAMI6 Working Group, and the mobile terminal based on the MIPv6 mechanism may perform data transmission through at least one interface based on a plurality of CoAs stored in a binding cash entry.

FIG. 1 is a diagram representing a BID sub-option field in binding update information suggested by the IETF MONAMI6 Working Group.

As shown in FIG. 1, the BID sub-option field in the binding update information suggested by the IETF MONAMI6 Working Group includes one BID and one CoA corresponding to the BID. Here, a BID respectively corresponds to information on interfaces of a mobile terminal for performing data transmission through a plurality of wired/wireless interfaces.

The mobile terminal respectively applies a plurality of CoAs to correspond to the respective interfaces through which data may be transmitted/received, and performs binding update by generating the binding update information including the BID for identifying the CoAs respectively allocated to the interfaces and transmitting the binding update information to a home agent (HA) and a correspondent node (CN). The HA and the CN store the binding update information received from the mobile terminal in the binding cash entry, and the mobile terminal transmits data through the plurality of CoAs allocated to home addresses and the respective interfaces based on the binding update information.

However, the BID sub-option suggested by the IETF MONAMI6 Working Group does not include information on different network environments and data characteristics respectively corresponding to the plurality of interfaces, and therefore it is difficult to substantially use.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a multiple care-of address registration method by using a binding update identifier (BID) sub-option including information on different network environment and data characteristics.

According to an exemplary embodiment of the present invention, in a multiple care-of address registration method of a mobile terminal having a plurality of care-of addresses respectively corresponding to a plurality of interfaces for performing data transmission, a binding update identifier sub-option field including current used interface and data characteristics and corresponding to one interface of the plurality of interfaces is generated, the binding update identifier sub-option field is transmitted to a home agent and a correspondent node, a care-of address corresponding to a binding update identifier is stored, and binding update is performed.

In addition, according to another exemplary embodiment of the present invention, in a multiple care-of address registration method of a mobile terminal having a plurality of care-of addresses respectively corresponding to a plurality of interfaces for performing data transmission by using a binding update identifier sub-option field, the binding update identifier sub-option field includes information on a number of interfaces that may be used by the mobile terminal and information on a type of interface that may be supported by the mobile terminal.

### BRIEF DESCRIPTION OF THE DRAWINGS

FIG. 1 is a diagram representing a binding update identifier (BID) sub-option field in binding update information suggested by the IETF MONAMI6 Working Group.

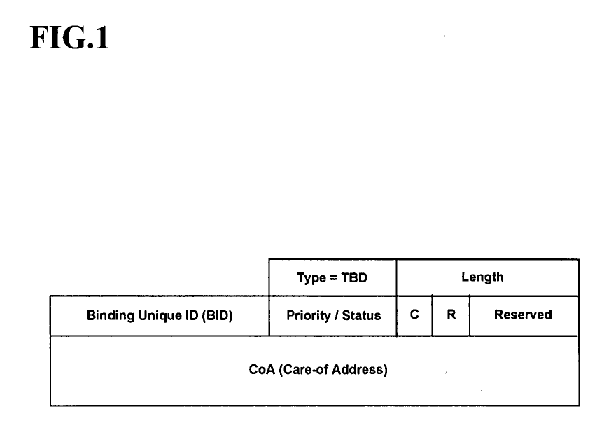

FIG. 2 is a diagram representing a BID sub-option field according to an exemplary embodiment of the present invention.

FIG. 3 is a diagram representing a binding update method according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” and “comprising”, will be understood to imply the inclusion of stated elements but not the exclusion of any other elements.

A multiple care-of address registration method according to an exemplary embodiment of the present invention will now be described with reference to the figures.

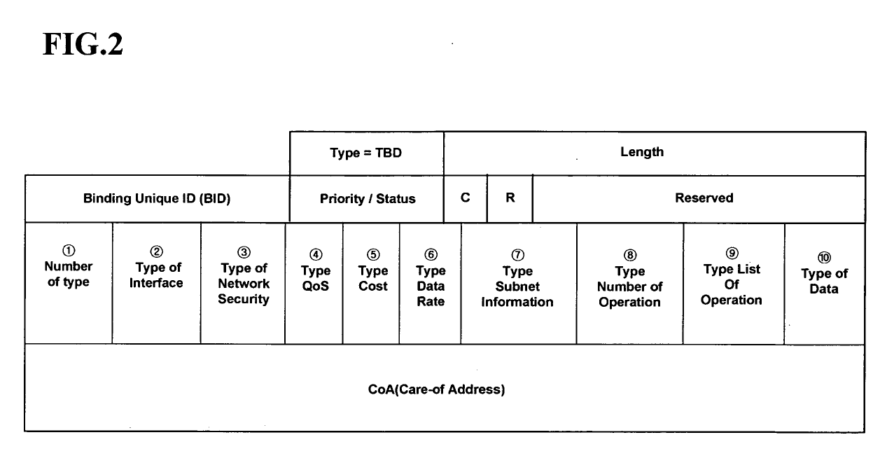

FIG. 2 is a diagram representing a binding update identifier (BID) sub-option field according to the exemplary embodiment of the present invention.

The BID sub-option field according to the exemplary embodiment of the present invention includes a BID information field, a type field Type, a care-of address flag field C, an erase flag field R, a length field Length, a binding priority setting field Priority/Status, and an interface and data characteristic information field.

The BID information field for indicating the BID information that is binding-updated through the BID sub-option field has an unsigned integer value of 16 bits.

The type field Type defines a type value of the BID, and the care-of address flag field C indicates a state of whether a mobile terminal stores a care-of address corresponding to the BID when the binding update is performed. The erase flag field R indicates a state of whether to request for the BID information shown in the BID information field among the binding cash entries stored in the HA and the CN through the binding update.

The length field Length has a value established according to a value of the care-of address flag field C. For example, the value of the length field Length is established to be “4” when the value of the care-of address flag field C is established such that the mobile terminal stores the care-of address corresponding to the BID when the binding update is performed, and otherwise, it is established to be “20”.

The binding priority setting field Priority/Status establishes a priority of the BID when the binding update is performed, and a priority value is expressed as an unsigned integer of 8 bits having values 0 to 255. In this case, a higher priority value has higher priority, and the priority value of 0 is the lowest priority. The HA and the CN allow the mobile terminal to perform transmission through the interface corresponding to the binding information stored in the binding cash entry based on the priority value of the binding priority setting field Priority/Status.

The interface and data characteristic information field includes the following \textcircled{1} to \textcircled{10}.

\textcircled{1} Number of Type: a number of interfaces through which a mobile terminal performs data transmission

\textcircled{2} Type of Interface: types of interface that may be supported by a mobile terminal

\textcircled{3} Type of Network Security: a state of using IPsec

\textcircled{4} Type QoS: QoS requirements for each interface

\textcircled{5} Type Cost: a cost for each interface

\textcircled{6} Type Data Rate: a data rate for each interface

\textcircled{7} Type Subnet Information: a number of sub-networks included in each interface

\textcircled{8} Type Number of Operation: service provider identification information

\textcircled{9} Type List of Operation: service provider list information

\textcircled{10} Type of Data: data transmission method information for each interface

Here, the service provider identification information \textcircled{8} indicates all service providers in which the mobile terminal subscribes and uses a service, and the service provider list information \textcircled{9} indicates a list of service providers in which the mobile terminal currently uses a service. In addition, the state of using IPsec \textcircled{3} may be established to indicate that IPsec is not used when a value of \textcircled{3} is 0, and that it is used when the value is 1. Further, a value of the data transmission method information \textcircled{10} for each interface may be established to be 0 to 3, where a value of 0 indicates a default value, a value of 1 indicates a streaming method, a value of 2 indicates a transferring method, and a value of 3 indicates a VoIP method.

Differing from the BID sub-option field suggested by the IETF MONAMI6 Working Group, since the BID sub-option field according to the exemplary embodiment of the present invention additionally includes the interface and data characteristic information field, interfaces, characteristics of data, and characteristics of a different wireless network that are currently used by the mobile terminal may be stored in the HA and the CN through the binding update. Accordingly, the HA and the CN may control the mobile terminal to selectively use different interfaces according to the characteristics of data to be transmitted by the mobile terminal, and may dynamically provide services required by a user without changing the setting according to a mobile terminal user's environment.

For example, when it is assumed that the mobile terminal simultaneously has a wireless local area network (WLAN) interface and a code division multiple access (CDMA) 2000 interface, the BID sub-option field according to the exemplary embodiment of the present invention may selectively use interfaces as follows. The HA and the CN control the mobile terminal to use the WLAN interface for file transfer, and control the mobile terminal to use an interface that is serviced in a wide area (e.g., the CDMA 2000 interface) when a streaming service requiring QoS is provided.

In addition, according to the binding update method suggested by the IETF MONAMI6 Working Group, the mobile terminal performs the binding update for one interface after one interface, and therefore an overhead may be generated by an increase of the number of binding updates when there are a large number of interfaces for performing the data transmission by the mobile terminal. Particularly, when hand-off frequently occurs, the overhead is problematically generated by the increase of the number of binding updates

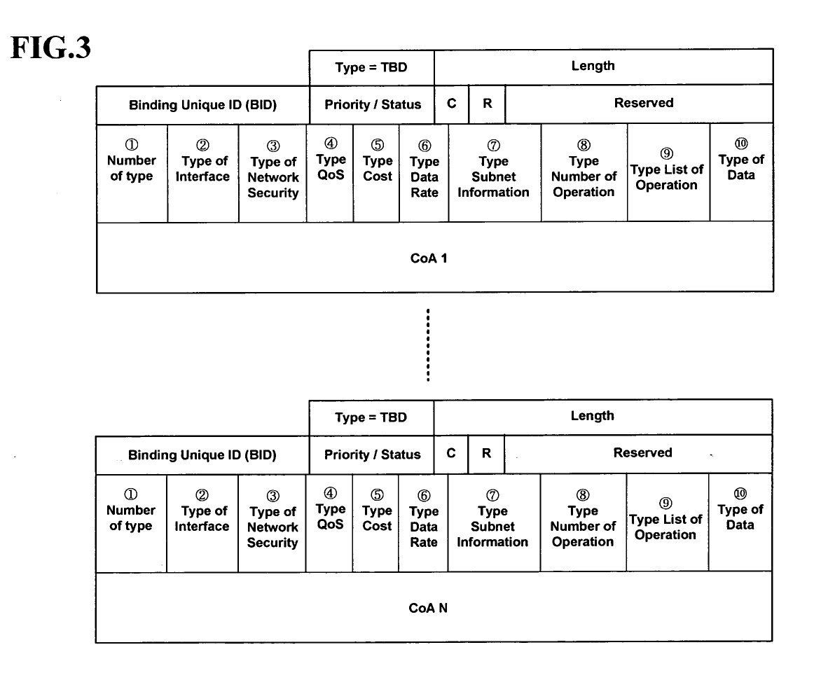

A binding update method for preventing the overhead according to the exemplary embodiment of the present invention will now be described with reference to FIG. 3.

FIG. 3 is a diagram representing the binding update method according to the exemplary embodiment of the present invention.

As shown in FIG. 3, in the binding update method according to the exemplary embodiment of the present invention, N BID sub-option fields according to the exemplary embodiment of the present invention are simultaneously transmitted to the HA and the CN. Here, the N BID sub-option fields are the number of interfaces for performing the data transmission by the mobile terminal at a current location. That is, the mobile terminal performs the binding update for all interfaces that may be currently used. Accordingly, the overhead caused by the increase of the number of binding updates may be prevented. In addition, the mobile terminal generates and transmits the binding update information to the HA and the CN excepting the interface information that is irrelevant to the hand-off, and therefore the size of the binding update information may be reduced.

Since the BID sub-option field according to the exemplary embodiment of the present invention includes information on the interfaces and data that are now used by the mobile terminal, and the HA and the CN generate the binding cash entry based on the information, and data transmission required by a mobile terminal user and a current network situation may be performed. That is, the HA and the CN may simultaneously use all available interfaces to increase data transmission bandwidth, select a low cost interface based on cost information, or select an interface for performing quickest data transmission based on a data transmission speed.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described, according to the exemplary embodiment of the present invention, since the BID sub-option field according to the exemplary embodiment of the present invention includes information on the interfaces and data that are now used by the mobile terminal, and the HA and the CN generate the binding cash entry based on the information, the data transmission required by a mobile terminal user and a current network situation may be performed.

In addition, since the BID sub-option field includes the plurality of CoAs and the binding update information excepting the information that is irrelevant to the hand-off is generated, the overhead caused by the binding update of the mobile terminal may be prevented.

What is claimed is:

1. A multiple care-of address registration method of a mobile terminal having a plurality of care-of addresses respectively corresponding to a plurality of interfaces for performing data transmission, the multiple care-of address registration method comprising:
generating a binding update identifier sub-option field including current used interface and data characteristics and corresponding to one interface of the plurality of interfaces; and
transmitting the binding update identifier sub-option field to a home agent and a correspondent node, storing a care-of address corresponding to a binding update identifier, and performing binding update.

2. The multiple care-of address registration method of claim 1, wherein the binding update identifier sub-option field comprises information on a number of interfaces that may be used by the mobile terminal and information on a type of interface that may be supported by the mobile terminal.

3. The multiple care-of address registration method of claim 2, wherein the binding update identifier sub-option field further comprises data security information, QoS requirement information, cost information, data rate information, data transmission method information, service provider identification information, service provider list information, and information on a number of sub-networks, with respect to the currently used interface information.

4. The multiple care-of address registration method of claim 1, wherein, in the performing of the binding update, the mobile terminal simultaneously performs the binding update for all interfaces that may be currently used.

5. A multiple care-of address registration method of a mobile terminal having a plurality of care-of addresses respectively corresponding to a plurality of interfaces for performing data transmission by using a binding update identifier sub-option field, wherein the binding update identifier sub-option field comprises information on a number of interfaces that may be used by the mobile terminal and information on a type of interface that may be supported by the mobile terminal.

6. The multiple care-of address registration method of claim 5, wherein the binding update identifier sub-option field further comprises data security information, QoS requirement information, cost information, data rate information, data transmission method information, service provider identification information, service provider list information, and information on a number of sub-networks, with respect to the currently used interface information.
